(19) United States
(12) Patent Application Publication
(10) Pub. No.: US 2006/0104741 A1
(43) Pub. Date: May 18, 2006

(54) Bolted fastener for joining components

(76) Inventors: Richard Schutz, Wien (AT); Gunter Trojek, Moosbrunn (AT)

Correspondence Address: SCHWEITZER CORNMAN GROSS & BONDELL LLP, 292 MADISON AVENUE - 19th FLOOR, NEW YORK, NY, 10017, US

(21) Appl. No.: 11/268,195

(22) Filed: Nov. 7, 2005

(30) Foreign Application Priority Data
Nov. 17, 2004 (EP) 04405709.9

(51) Int. Cl. F16B 35/02

(52) U.S. Cl. 411/383

(57) ABSTRACT

A bolted fastener joins a first angle-piece to a second angle-piece of an escalator or moving walk brush unit. The fastener includes an adapter arranged between the two components, and precise two-dimensional position-changing of one component relative to the other or to its former position, without auxiliary means. A bolt and nut holds the two components and the adapter together.

The invention relates to a bolted fastener for joining components.

### BACKGROUND OF THE INVENTION

Components that are joined by means of bolted fasteners are normally joined together by means of at least two bolts that pass through holes arranged in the components. For the purpose of aligning the components, the holes are formed as elongated holes, each elongated hole allowing a change of position in one dimension.

A disadvantage of such a bolted fastening is the high outlay of material and work for joining the components. The outlay becomes increasingly significant as the number of joints needing to be made increases.

Accordingly, the present invention provides a solution, avoiding the disadvantages of known devices and setting forth a bolted fastener that is easy to manufacture.

### BRIEF DESCRIPTION OF THE INVENTION

The present invention is a bolted fastener that includes an adapter which creates a guiding joint between the components to be fastened together. The adapter may be positioned between the components, and may be in the form of a plate having projections that extend into the elongated holes in the components, allowing the components to be pre-aligned for bolt insertion. A bolt or comparable fastener passes through the components and the adapter. A nut on the bolt secures the components and adapter in position.

The advantages achieved by the invention include a bolted fastener according to the invention allows precise two-dimensional position-changing without auxiliary means. Installation, adjustment, and release of the bolted fastener can be performed simply, accurately, and quickly. Furthermore, the outlay for bolting material such as bolts, nuts and washers is decreased. With a non-rotatable round-headed bolt, installation with one hand and exact positioning of the component being joined with the free hand is possible. Relative to the usual fasteners with two or three bolts, the bolted fastener has the advantage that releasing the joints can be done with greater saving of time, more easily, and quicker than with conventional bolted fasteners.

### BRIEF DESCRIPTION OF THE DRAWINGS

The present invention is explained in greater detail in the following description of the invention, when reviewed in association with the attached figures, wherein:

FIG. 1 is a front elevation view of a construction incorporating a bolted fastener according to the invention;

FIG. 2 is a plan view of the construction of FIG. 1;

FIG. 3 is a side elevation view of the construction of FIG. 1;

FIG. 4 is a plan view of an adapter of the bolted fastener according to the invention;

FIG. 5 is a front elevation view of the adapter;

FIG. 6 is a side elevation view of the adapter;

FIG. 7 is a three-dimensional view of the adapter; and

FIG. 8 is a three-dimensional exploded view of the construction of FIG. 1 including the bolted fastener according to the invention.

### DETAILED DESCRIPTION OF THE INVENTION

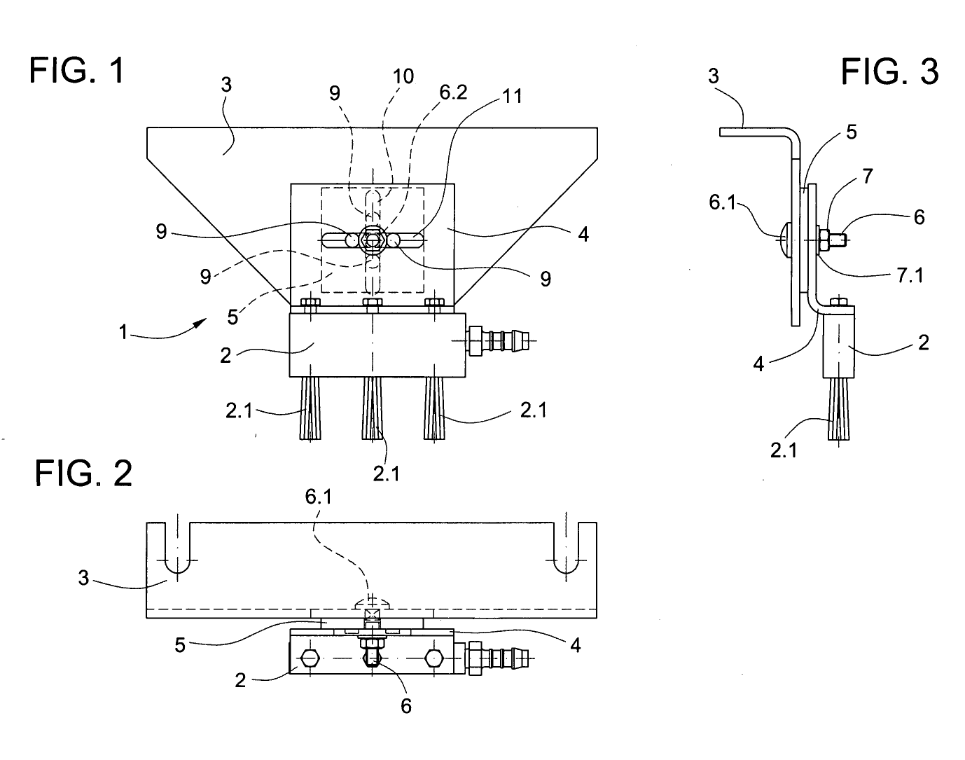

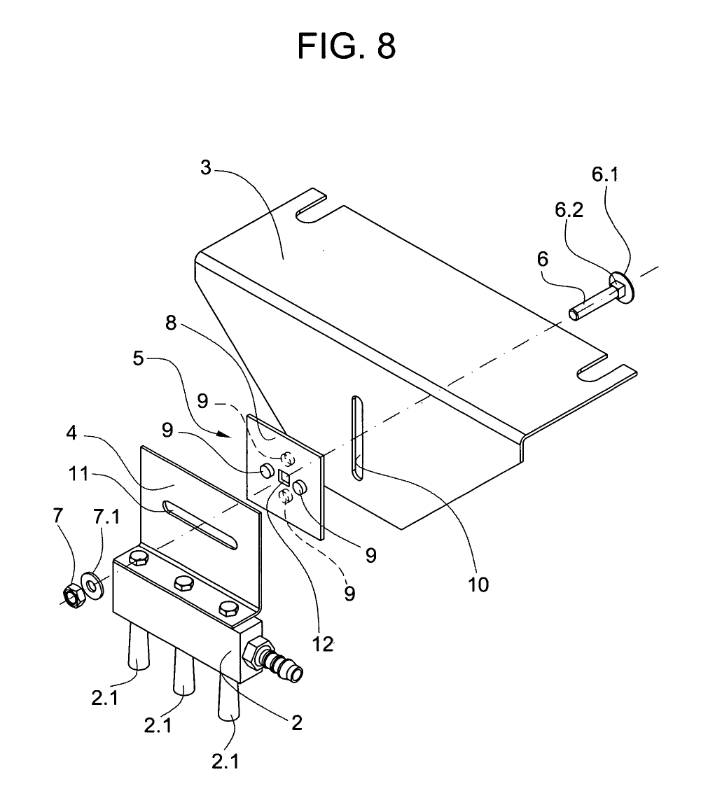

FIGS. 1 to 3 and FIG. 8 show a bolted fastener 1 according to the invention for joining, for example, a brush unit 2 to a first angle-piece 3 of a (not shown) step-chain lubricator of an escalator.

In the case of an escalator or moving walk with, for example, a glass balustrade, a step-chain lubricator with brush unit 2 or a pallet-chain lubricator with a brush unit 2, is built into the upper head-piece. The step-chain lubricator, specifically the brush unit 2, is provided for the purpose of lubricating the step-chain or pallet chain. The step-chain or pallet-chain connects the step-band or pallet-band that transports the passengers of the escalator or moving walk up or down. For a step-band or pallet-band, one step-chain or pallet-chain is required on each side. These step-chains or pallet-chains are subjected to heavy loading and for that reason must be lubricated with chain oil by means of brushes 2.1.

The brush unit 2 is arranged on a second component, for example a second angle-piece 4. The bolted fastener 1 according to the invention joins a first component, for example a first angle-piece 3, to the second component, for example the second angle-piece 4. The first angle-piece 3 is, for example, arranged on a supporting element of the escalator head-piece or moving-walk head-piece. An adapter 5 arranged between the angle-pieces 3, 4 allows precise two-dimensional position-changing of the brush unit 2 relative to the first angle-piece 3, or relative to its former position, without auxiliary means. A bolt 6, with a wing nut or nut 7, and washer 7.1, holds the two angle-pieces 3, 4 and the adapter together.

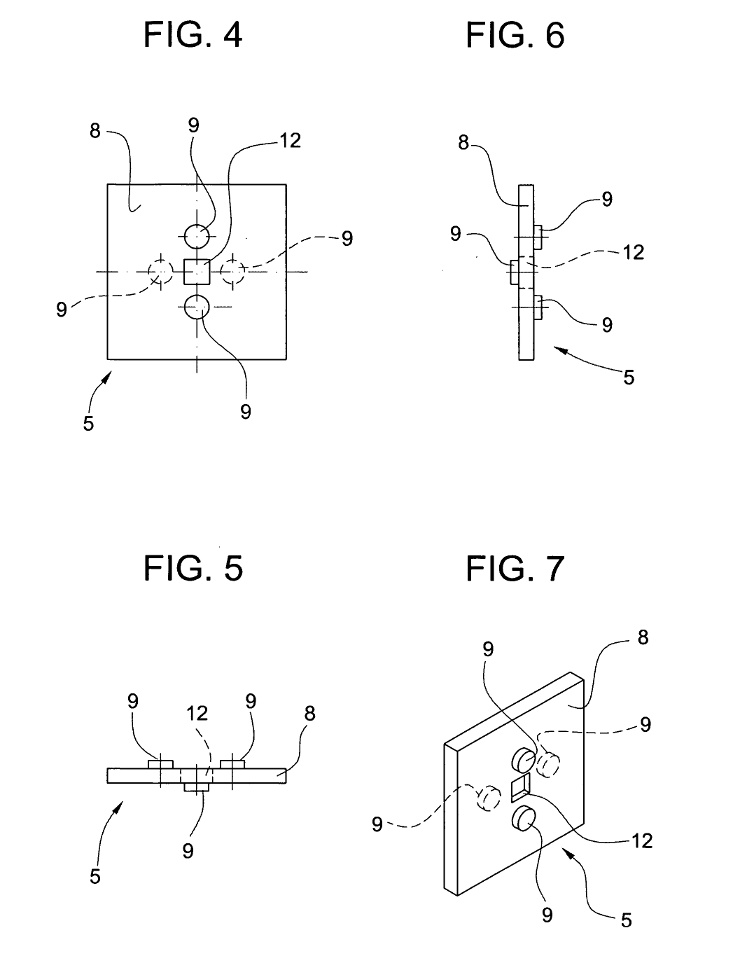

FIGS. 4 to 7 show details of the adapter 5, which is executed as a plate 8 with studs 9. The adapter 5 is provided as a connecting component between the elements to be joined, such as angle-pieces 3 and 4, and provides a guiding connection between the elements. The plate 8 has on both its front side and its back side respectively at least two projections or protuberances or embossings executed in the form of studs 9. The studs 9 are, for example, stamped or hammered out of the plate 8. The studs can also be executed as bolts, pins, bushes, tubes or the like.

The studs 9 on the back side of the plate 8 project into a first elongated hole 10 arranged in the first angle-piece 3. The studs 9 of the front side of the plate 8 project into a second elongated hole 11 arranged in the second angle-piece 4. The connecting axis of the studs 9 on the one side of the plate is arranged at a right angle to the connecting axis of the two studs 9 on the other side of the plate. In relation to the plane of the plate, the elongated holes 10, 11 are arranged at right angles to each other. The studs 9, guided in the elongated holes 10, 11 allow, without auxiliary means, precise two-dimensional alignment or changing of the position of the brush unit 2 relative to the first angle-piece 3 or to its former position.

Provided at the point at which the diagonals of the plate 8 intersect (the mid-point of the plate 8) is a square hole 12. The head 6.1 of bolt 6 is executed as a round head. A square neck 6.2 of the bolt has a sliding fit in the first elongated hole 10 of the first angle-piece 3 and projects into the square hole 12 of the plate 8. When the nut 7 is tightened, the bolt 6 cannot turn. With the non-rotatable round-head bolt 6, installation with one hand and exact positioning of the brush unit with the free hand is possible. Relative to a conventional fastener with two to three bolts, the bolted fastener 1 has the advantage that release of the fastener can be performed with a time-saving, more easily, and faster.

The bolted fastener 1 according to the invention can also be used on the runners and/or guide rails, as well as on the truss ribs and on the balustrade post, or on the comb-plate fastening or on the balustrade, as well as on all other angle connections of the escalator or of the moving walk.

The bolted fastener according to the invention can also be used for joining components in devices other than escalators or moving walks as, for example, elevators, aerial cableways, cable railways, hoisting equipment, or machines.

We claim:

1. A bolted fastener for joining components, characterized in that the bolted fastener includes an adapter that creates a guiding joint between a first component and a second component to be joined.

2. The bolted fastener according to claim 1, characterized in that the adapter is located between the first component and the second component.

3. The bolted fastener according to claim 1 or 2, characterized in that the adapter comprises a plate having a first side with projections for projecting into an elongated hole located in the first component and a second side with projections for projecting into an elongated hole located in the second component.

4. The bolted fastener according to claim 3, further comprising a bolt for penetrating through the first and second components and the plate, and a nut mountable on an end of the bolt, the bolt and nut together joining the components and the plate in a releasable manner.

5. The bolted fastener according to claim 4, characterized in that the plate has a square hole and the bolt has a square neck at a second end for fitting in a sliding manner into the elongated hole of the first component and in an aligned manner into the square hole.

6. A method for joining a brush unit to a component that comprises utilizing a bolted fastener of claim 4.

7. An escalator or moving walk having at least one bolted fastener according to claim 4.

8. A method for joining components of an escalator or moving walk that comprises utilizing a bolted fastener of claim 4.
